(19) United States
(12) Patent Application Publication
(10) Pub. No.: US 2025/0351235 A1
(43) Pub. Date: Nov. 13, 2025

(54) CERAMIC HEATER

(71) Applicant: MICO CERAMICS LTD., Anseong-si, Gyeonggi-do (KR)

(72) Inventor: Jung Chul JIN, Anseong-si, Gyeonggi-do (KR)

(21) Appl. No.: 18/845,430

(22) PCT Filed: Apr. 21, 2023
(86) PCT No.: PCT/KR2023/005426

§ 371 Date: Jan. 1, 2025

(30) Foreign Application Priority Data
May 13, 2022 (KR) 10-2022-0058740

(51) Int. Cl. H05B 3/28; H05B 1/02; H05B 3/03; H05B 3/18

(52) U.S. Cl. CPC H05B 3/283; H05B 1/02; H05B 3/03; H05B 3/18; H05B 2203/005

(57) ABSTRACT

The present invention relates to a two-zone heating element which is embedded in a ceramic heater, the two-zone heating element comprising: first and second heating parts which can be independently controlled by a power supply device; a first non-heating part which is disposed between first and second sub-heating portions constituting the first heating part and electrically connects the first and second sub-heating portions to each other; and a second non-heating part which is disposed between the second heating part and a first electrode terminal and electrically connects the second heating part and the first electrode terminal to each other.

### FIELD OF THE INVENTION

The present disclosure relates to a ceramic heater and, more specifically, to a ceramic heater with improved reliability.

### BACKGROUND OF THE INVENTION

Ceramic heaters are used to heat-treat heat treatment objects for various purposes such as semiconductor wafers, glass substrates, and flexible substrates at a predetermined heating temperature. Generally, a ceramic heater includes a heater body made of a ceramic plate and a heater support mounted on the lower portion of the heater body, wherein the heater body includes a heat generator with a predetermined resistance. The temperature distribution on the heating surface of the ceramic heater can be adjusted by the arrangement and design of heat generators embedded in the ceramic plate. Specifically, the temperature distribution on the heating surface of the ceramic heater can be adjusted by changing the interval, shape, material, and thickness of the heat generators.

The temperature distribution formed on the heating surface of the ceramic heater may be variously required depending on the properties of the heat treatment objects. If a ceramic heater is designed using only one heat generator, various temperature distributions can be implemented by changing the embedding interval, embedding shape, material, and thickness of the heat generator embedded in the ceramic heater. However, because the ceramic plate of the ceramic heater has a high thermal conductivity, it is difficult to uniformly implement, in respective zones, various temperature distributions required depending on the properties of heat treatment objects using a heat generator controlled by the same power. Therefore, recently, ceramic heaters embedded with two or more heat generators capable of independent control have been proposed.

FIG. 1 is a view exemplifying the structure of a 2-zone heat generator embedded in a conventional ceramic heater. As illustrated in FIG. 1, the conventional 2-zone heat generator 10 includes a first heating element 11, a second heating element 12, and a non-heating element 13.

A first electrode terminal 20 and a second electrode terminal 30 are embedded in the ceramic plate corresponding to the central portion of the heat generator 10. The first electrode terminal 20 is in contact with the lower surface of the heat generator 10 and serves to electrically interconnect the first heating element 11 of the heat generator 10 and a first heat generator rod (not illustrated). The second electrode terminal 30 is in contact with the lower surface of the heat generator 10 and serves to electrically interconnect the non-heating element 13 of the heat generators 10 and a second heat generator rod (not illustrated).

The first heating element 11 is disposed at a position corresponding to the inner zone of the heating surface of the ceramic heater, and the second heating element 12 is disposed at a position corresponding to the outer zone of the heating surface of the ceramic heater. The first and second heating elements 11 and 12 are spaced apart from each other by a predetermined distance. In addition, the first and second heating elements 11 and 12 are electrically separated and driven independently of each other.

The non-heating element 13 is disposed between the second electrode terminal 30 and the second heating element 12 and serves to electrically interconnect the second electrode terminal 30 and the second heating element 12. The non-heating element 13 extends from the center point of the heating surface of the ceramic heater toward the edge. In additionally, the non-heating element 13 is generally configured in a straight structure with a length of 100 mm to 120 mm.

However, in the case of the conventional 2-zone heat generator 10, there is a problem in that, during a sintering/heat treatment process, cracks occur at various locations within the section where the ceramic plate and the non-heating element 13 are in contact with each other due to a difference in thermal expansion rate between the aluminum nitride material constituting the ceramic plate and the metal material constituting the non-heating element 13. To solve this problem, it is necessary to find a way to shorten the length of the non-heating element 13.

### DETAILED DESCRIPTION OF THE INVENTION

### Technical Problem

In an aspect, the present disclosure solves the above-described problems and other problems. The present disclosure provides a ceramic heater with improved reliability.

In addition, the present disclosure provides a ceramic heater with improved temperature uniformity.

In addition, the present disclosure provides a ceramic heater having a multi-zone heat generator embedded therein, which includes two or more independently controllable heating elements and two or more non-heating elements connected to the heating elements.

Furthermore, the present disclosure provides a ceramic heater having a multi-zone heat generator therein, which includes two or more non-heating elements having a shortened straight length compared to a conventional heater.

### Technical Solution

In view of the foregoing, an aspect of the present disclosure provides a ceramic heater including a 2-zone heat generator embedded therein. The 2-zone heat generator includes: first and second heating elements configured to be independently controllable by a power supply; a first non-heating element arranged between first and second sub-heating elements constituting the first heating element and electrically interconnecting the first and second sub-heating elements; and a second non-heating element disposed between the second heating element and a first electrode terminal and electrically interconnecting the second heating element and the first electrode terminal.

Another embodiment of the present disclosure provides a ceramic heater including a 4-zone heat generator embedded therein. The 4-zone heat generator includes: first to fourth heating elements configured to be independently controlled by a power supply; first and second non-heating elements arranged opposite to each other with respect to a first axis of symmetry between the first heating element and the second heating element, and disposed at a predetermined distance from a center of the 4-zone heat generator; and third and fourth non-heating elements arranged opposite to each other with respect to a second axis of symmetry between the third heating element and the fourth heating element, and extending from first and second electrode terminals disposed at a center of the 4-zone heat generator toward the third and fourth heating elements.

Another embodiment of the present disclosure provides a ceramic heater including a 6-zone heat generator embedded therein. The 6-zone heat generator includes: first to sixth heating elements configured to be independently controlled by a power supply; first to third non-heating elements disposed at a predetermined distance from a center of the 6-zone heat generator and arranged at 120-degree intervals around a center of the 6-zone heat generator; and fourth to sixth non-heating elements extending from the first to third electrode terminals disposed in the center of the 6-zone heat generator toward the fourth to sixth heating elements, respectively, and arranged at 120-degree intervals around the center of the 6-zone heat generator.

Effect of the Invention

According to at least one of the embodiments of the present disclosure, a 2-zone heat generator including two non-heating elements with a shortened straight length compared to the conventional ones is provided. Therefore, the thermal stress caused by the non-heating elements can be reduced, and thereby the occurrence of cracks in the section where the non-heating elements and the ceramic plate come into contact can be effectively reduced.

In addition, according to at least one of the embodiments of the present disclosure, a 4-zone heat generator including four non-heating elements with a shortened straight length compared to the conventional ones is provided. Therefore, the thermal stress caused by the non-heating elements can be reduced, and thereby the occurrence of cracks in the section where the non-heating elements and the ceramic plate come into contact can be effectively reduced.

In addition, according to at least one of the embodiments of the present disclosure, a 6-zone heat generator including six non-heating elements with a shortened straight length compared to the conventional ones is provided. Therefore, the thermal stress caused by the non-heating elements can be reduced, and thereby the occurrence of cracks in the section where the non-heating elements and the ceramic plate come into contact can be effectively reduced.

However, the effects which can be obtained by the ceramic heater according to the embodiments of the present disclosure are not limited to those described above, and other effects not mentioned above will be clearly understood by a person ordinarily skilled in the art, to which the present disclosure belongs, from the following description.

### BRIEF DESCRIPTION OF THE DRAWINGS

FIG. 1 is a view exemplifying the structure of a 2-zone heat generator embedded in a conventional ceramic heater;

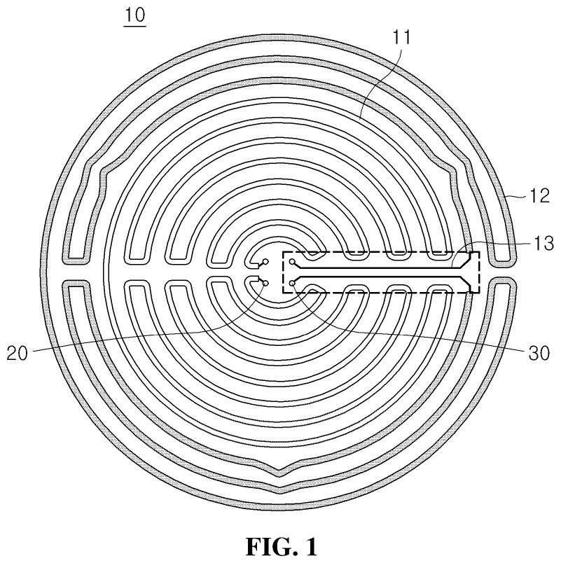

FIG. 2 is a perspective view illustrating the external appearance of a ceramic heater according to an embodiment of the present disclosure;

FIG. 3 is a cross-sectional view illustrating the configuration of the ceramic heater according to an embodiment of the present disclosure;

FIG. 4 is a view illustrating the structure of a 2-zone heat generator according to an embodiment of the present disclosure;

FIGS. 5A-5B are views illustrating the detailed structure of elements constituting the 2-zone heat generator of FIG. 4;

FIGS. 6A-6B are enlarged views of portion A in FIG. 4;

FIG. 7 is a view illustrating the structure of a 4-zone heat generator according to an embodiment of the present disclosure;

FIGS. 8A-8B are views illustrating the detailed structure of elements constituting the 4-zone heat generator of FIG. 7;

FIG. 9 is a view illustrating the structure of a 6-zone heat generator according to an embodiment of the present disclosure; and

FIGS. 10A-10B are views illustrating the detailed structure of elements constituting the 6-zone heat generator of FIG. 9.

### MODE FOR IMPLEMENTING THE INVENTION

Hereinafter, embodiments disclosed herein will be described in detail with reference to the accompanying drawings, and regardless of drawing numbers, the same or similar elements will be assigned the same reference numerals, and redundant descriptions thereof will be omitted. Hereinafter, in the description of embodiments according to the present disclosure, when it is described that each layer (film), a region, a pattern, or structure is formed “above/on” or “below/under” a substrate, each layer (film), a region, a pad or a pattern, “formed above/on” and “formed below/under” include the case of being “directly formed” or “indirectly formed via another layer”. In addition, the criterion for above/on or below/above for each layer will be described with reference to the drawings. In the drawings, the thickness or size of each layer is exaggerated, omitted, or schematically illustrated for convenience and clarity of description. In addition, the size of each component does not fully reflect the actual size.

In addition, in describing the embodiments disclosed herein, when it is determined that detailed descriptions of related known technologies may obscure the gist of the embodiments disclosed herein, the detailed descriptions will be omitted. In addition, it should be understood that the accompanying drawings are only for easy understanding of the embodiments disclosed herein, and that the technical idea disclosed herein is not limited by the accompanying drawings, and includes all changes, equivalents, and substitutes included in the spirit and technical scope of the present disclosure.

The present disclosure proposes a ceramic heater with improved reliability. In addition, the present disclosure proposes a ceramic heater with improved temperature uniformity. In addition, the present disclosure proposes a ceramic heater having a multi-zone heat generator embedded therein, which includes two or more independently controllable heating elements and two or more non-heating elements connected to the two or more heating elements. In addition, the present disclosure proposes a ceramic heater having a multi-zone heat generator embedded therein, which includes two or more non-heating elements having a shortened straight line length compared to the conventional heater.

Hereinafter, various embodiments of the present disclosure will be described in detail with reference to the drawings.

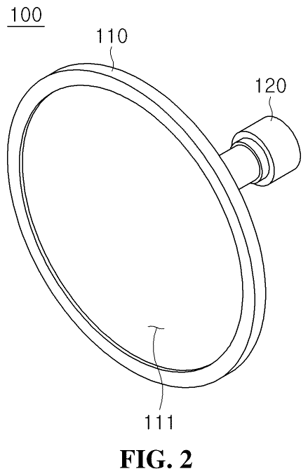

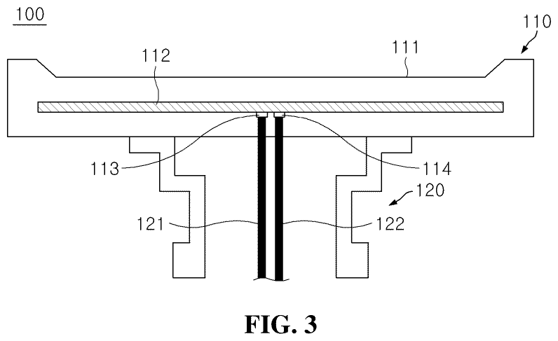

FIG. 2 is a perspective view illustrating the external appearance of a ceramic heater according to an embodiment of the present disclosure, and FIG. 3 is a cross-sectional view illustrating the configuration of the ceramic heater according to an embodiment of the present disclosure.

Referring to FIGS. 2 and 3, the ceramic heater 100 according to an embodiment of the present disclosure is a semiconductor device that supports heat treatment objects for various purposes such as semiconductor wafers, glass substrates, and flexible substrates, and heats the heat treatment objects to a predetermined temperature.

The ceramic heater 100 may include a heater body 110 configured to transmit heat while stably supporting a heat treatment object (not illustrated), and a heater support portion 120 mounted on a lower portion of the heater body 110. Meanwhile, although not illustrated in the drawing, an adhesive layer (not illustrated) may be provided between the heater body 110 and the heater support 120.

The heater body 110 may be a plate-shaped structure having a predetermined shape. For example, the heater body 110 may be a circular plate-shaped structure, but is not necessarily limited thereto.

A pocket region (or a cavity region) 111 having a structure recessed with a predetermined level difference may be predetermined in the upper portion of the heater body 110 such that a heat treatment object, such as a wafer, can be stably mounted. The upper surface of the heater body 110 corresponding to the pocket region may have excellent flatness. This is to ensure that the heat treatment object mounted in the chamber is arranged horizontally without tilting to one side.

The heater body 110 may include multiple ceramic plates (not illustrated) made of a ceramic material with excellent thermal conductivity, and may be shaped through processes of compacting and sintering the multiple ceramic plates. Here, the ceramic material may be at least one of Al2O3, Y2O3, Al2O3/Y2O3, ZrO2, autoclaved lightweight concrete (AlC), TiN, AlN, TiC, MgO, CaO, CeO2, TiO2, BxCy, BN, SiO2, SiC, YAG, mullite, and AlF3, and more preferably aluminum nitride (AlN).

The heater body 110 may include a heat generator 112 and multiple electrode terminals 113 and 114 in contact with the lower surface of the heat generator 112. Meanwhile, although not illustrated in the drawings, the heater body 110 may include a high-frequency electrode for performing a radio frequency (RF) grounding function and/or an electrostatic chuck function.

The heat generator 112 performs a function of heating the heat treatment object located on the upper surface of the heater body 110 to a constant temperature in order to perform a vapor deposition process and an etching process smoothly in a semiconductor manufacturing process.

The heat generator 112 may be embedded in the heater body 110 corresponding to the position of the heat treatment object. The heat generator 112 may be embedded in the heater body 110 parallel to the heat treatment object such that the heating temperature can be uniformly controlled depending on a location in order to uniformly heat the heat treatment object as a whole, and the distance by which heat is transferred to the heat treatment object can be maintained constant at almost all locations.

The heat generator 112 may have a shape that corresponds to the shape of the heat treatment object. In addition, the heat generator 112 may have a plate-shaped coil shape or a flat plate shape with a heating wire (or a resistance wire).

The heat generator 112 may be made of tungsten (W), molybdenum (Mo), molybdenum carbide (Mo2C, MoC, or Mo3C2), silver (Ag), gold (Au), platinum (Pt), niobium (Nb), titanium (Ti), or alloys thereof.

In particular, the heat generator 112 according to the present embodiment may be a multi-zone heat generator that includes two or more independently controllable heating elements and two or more non-heating elements connected to the two or more heating elements. The heat generator 112 has two or more non-heating elements with a shortened straight length compared to the conventional ones, thereby effectively reducing the thermal stress caused by the non-heating elements.

The multiple electrode terminals 113 and 114 may be in contact with the lower surface of the heat generator 112 to perform the function of electrically interconnecting the heating elements of the heat generator 112 and multiple heat generator rods 121 and 122.

The multiple electrode terminals 113 and 114 may be embedded in a ceramic plate corresponding to the central portion of the heat generator 112, that is, the portion where the heater body 110 and the heater support 120 are in contact with each other.

The multiple electrode terminals 113 and 114 may be made of a metal material with excellent electrical conductivity. As an example, the multiple electrode terminals 113 and 114 may be made of tungsten (W), molybdenum (Mo), silver (Ag), gold (Au), niobium (Nb), titanium (Ti), aluminum nitride (AIN), or an alloy thereof, and more preferably, may be made of molybdenum (Mo).

The heater support 120 may be mounted on the lower portion of the heater body 110, and serve to support the heater body 110. The heater support 120 may be coupled with the heater body portion 110 to form a ceramic heater 100 having an overall T-shape.

The heater support 120 may have a cylindrical tube shape with an empty space therein. This is to install multiple heat generator rods 121 and 122 connected to the heat generator 112 of the heater body 110 through the heater support 120.

The heater support 120 may be made of a ceramic material, the main components of which are the same as those of the heater body 110. As an example, the heater support 120 may be made of at least one of Al2O3, Y2O3, Al2O3/Y2O3, ZrO2, autoclaved lightweight concrete (AlC), TiN, AlN, TiC, MgO, CaO, Ce02, TiO2, BxCy, BN, SiO2, SiC, YAG, mullite, and AlF3, and more preferably, aluminum nitride (AlN).

The multiple heat generator rods 121 and 122 may be installed inside the heater support 120 to electrically interconnect the multiple electrode terminals 113 and 114 and an external power supply (not illustrated). Accordingly, the heating elements of the heat generator 112 embedded in the heater body 110 may be electrically connected to an external power supply via the multiple electrode terminals 113 and 114 and heat generator rods 121 and 122, and are independently controllable by the external power supply.

The multiple heat generator rods 121 and 122 may be made of a metal material with excellent electrical conductivity. As an example, the multiple rods 121 and 122 may be made of copper (Cu), aluminum (Al), iron (Fe), tungsten (W), nickel (Ni), silver (Ag), gold (Au), niobium (Nb), titanium (Ti), or an alloy thereof, and more preferably, nickel (Ni).

Meanwhile, this drawing exemplifies that two electrode terminals 113 and 114 and two heat generator rods 121 and 122 are installed in the ceramic heater 100, but the present disclosure is not necessarily limited thereto. The number of electrode terminals and heat generator rods installed in the ceramic heater corresponds to the number of heating elements that are independently controllable by the external power supply.

As described above, the ceramic heater according to an embodiment of the present disclosure includes a multi-zone heat generator including two or more non-heating elements with a shortened straight length compared to the conventional ones. Therefore, thermal stress caused by the non-heating elements can be reduced, and the occurrence of cracks in the section where the non-heating elements are in contact with the ceramic plate can be effectively reduced.

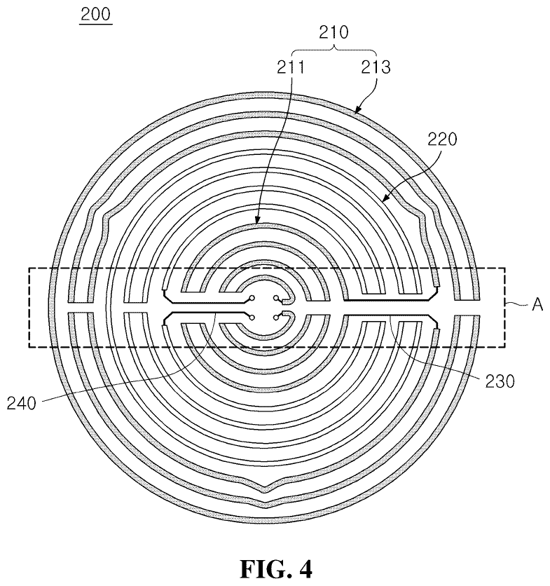

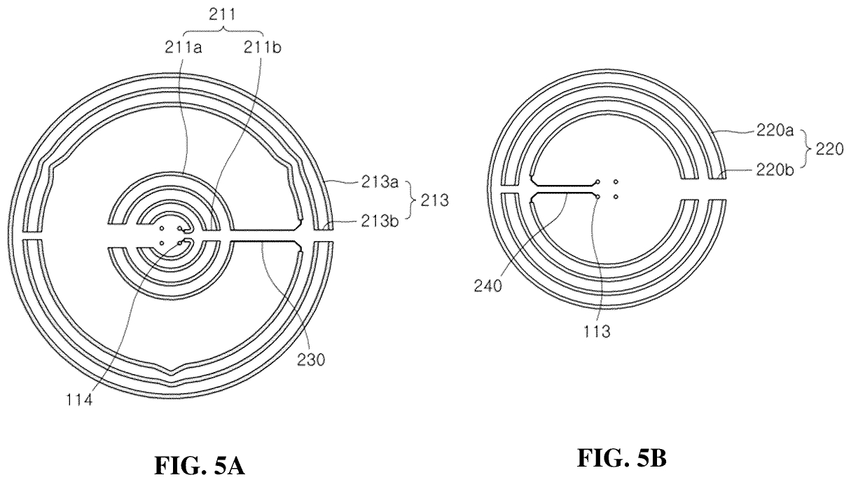

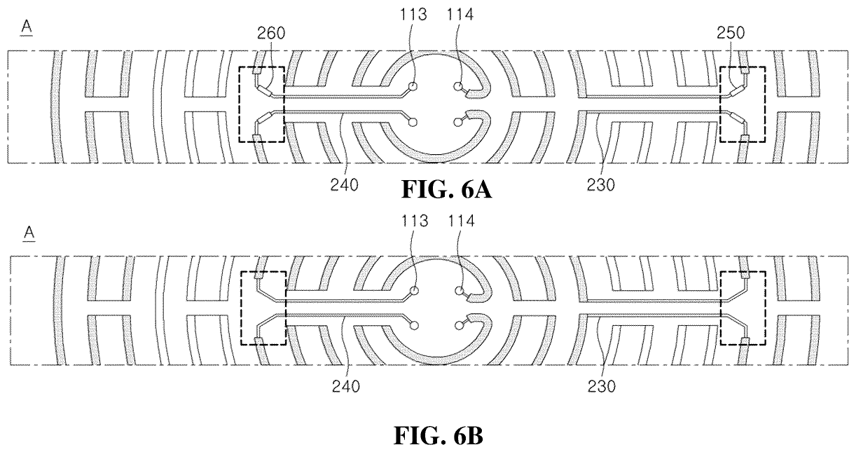

FIG. 4 is a view illustrating the structure of a 2-zone heat generator according to an embodiment of the present disclosure, FIGS. 5A-5B are views illustrating the detailed structure of elements constituting the 2-zone heat generator of FIG. 4, and FIG. 6A-6B are enlarged views of part A in FIG. 4.

Referring to FIGS. 4 to 6A-6B, the 2-zone heat generator 200 according to an embodiment of the present disclosure includes first and second heating elements 210 and 220 and first and second non-heating elements 230 and 240.

The first heating element (center/edge heating element) 210 may include a first sub-heating element (center heating element) 211 and a second sub heating element (edge heating element) 213. Here, the first and second sub-heating elements 211 and 213 may be electrically connected via the first non-heating element 230.

The first sub-heating element 211 may be provided at a location corresponding to the center zone of the heating surface of the ceramic heater. The first sub-heating element 211 may have a circular shape.

The first sub-heating element 211 may include multiple concentric circles 211a and multiple joints 211b interconnecting the multiple concentric circles 211a. A first end located inside the first sub-heating element 211 may be connected to a second electrode terminal 114, and a second end located outside the first sub-heating element may be connected to the first non-heating element 230.

The second sub-heating element 213 may be provided at a location corresponding to the edge zone of the heating surface of the ceramic heater. The second sub-heating element 213 may have a ring shape.

The second sub-heating element 213 may include multiple concentric circles 213a and multiple joints 213b interconnecting the multiple concentric circles 213a. An end present inside the second sub-heating element 213 may be connected to the first non-heating element 230.

The second heating element (middle heating element) 220 may be provided at a position corresponding to the middle zone of the heating surface of the ceramic heater. That is, the second heating element 220 may be disposed in the space between the first sub heating element 211 and the second sub heating element 213. The second heating element 220 may have a ring shape.

The second heating element 220 may include multiple concentric circles 220a and multiple joints 220b interconnecting the multiple concentric circles 220a. An end present inside the second heating element 220 may be connected to the second non-heating element 240.

The first and second heating elements 210 and 220 may be disposed on the same plane of the ceramic plate. As another embodiment, the first and second heating elements 210 and 220 may be disposed on different planes.

The first non-heating element 230 may be disposed between the first sub-heating element 211 and the second sub-heating element 213, and may perform the function of electrically interconnecting the first and second sub-heating elements 211 and 213. The first non-heating element 230 may extend in a straight form from a point on the first sub-heating element 211 to a point on the second sub-heating element 213.

Although not illustrated in the drawings, as another embodiment, the first non-heating element 230 may extend in a curved form from a point on the first sub-heating element 211 to a point on the second sub-heating element 213. As another embodiment, the first non-heating element 230 may extend from a point on the first sub-heating element 211 to a point on the second sub-heating element 213 in the form of a combination of straight and curved lines.

The first end of the first non-heating element 230 may be connected to the second end located outside the first sub-heating element 211, and the second end of the first non-heating element 230 may be connected to the second sub-heating element 213. In this case, the first non-heating element 230 may be connected to the second sub-heating element 213 via a first connector 250, as illustrated in FIG. 6A. The first connector 250 may be configured to include an opening where wires of different diameters, which constitute the first non-heating element 230 and the second sub-heating element 213 are tightly and fixedly fitted. As another embodiment, the first non-heating element 230 may be directly connected to the second sub-heating element 213 without a separate connector, as illustrated in FIG. 6B.

The first non-heating element 230 may include two metal wires arranged parallel to each other. The first non-heating element 230 may be provided such that the axis of symmetry between the two metal wires crosses the center of the heat generator 200.

The first non-heating element 230 may have a straight line length shorter than that of non-heating elements included in a conventional 2-zone heat generator. For example, when the straight line length of the conventional non-heating elements is 100 mm to 120 mm, the first non-heating element 230 may have a straight line length (60 mm to 70 mm) corresponding to about 60% of the conventional length.

The first non-heating element 230 may have a first length that is shorter than or equal to the straight line length between a point on the second sub-heating element 213 and the second electrode terminal 114.

The second non-heating element 240 may be arranged between the first electrode terminal 113 and the second heating element 220 and may perform the function of electrically interconnecting the first electrode terminal 113 and the second heating element 220. The second non-heating element 240 may extend in a straight form from the first electrode terminal 113 to a point on the second heating element 220.

Meanwhile, although not illustrated in the drawings, as another embodiment, the second non-heating element 240 may extend in a curved form from the first electrode terminal 113 to a point on the second heating element 220. As another example, the second non-heating element 240 may extend from the first electrode terminal 113 to a point on the second heating element 220 in a combination of straight and curved lines.

The first end of the second non-heating element 240 may be connected to the first electrode terminal 113, and the second end of the second non-heating element 240 may be connected to the end located inside the second heating element 220. In this case, the second non-heating element 240 may be connected to the second heating element 220 via a second connector 260, as illustrated in FIG. 6A. Likewise, the second connector 260 may be configured to include an opening where wires of different diameters, which constitute the second non-heating element 240 and the second-heating element 220 are tightly and fixedly fitted. As another embodiment, the second non-heating element 240 may be directly connected to the second heating element 220 without a separate connector, as illustrated in FIG. 6B

The second non-heating element 240 may include two metal wires arranged parallel to each other. The second non-heating element 240 may be provided such that the axis of symmetry between the two metal wires crosses the center of the heat generator 200.

The second non-heating element 240 may be arranged opposite to the first non-heating element 230 with respect to the center of the heat generator 200. The first and second non-heating elements 230 and 240 may be arranged on a straight line crossing the center of the heat generator 200, and more preferably on a horizontal line crossing the center of the heat generator 200.

The second non-heating element 240 may have a straight line length equal to or different from that of the first non-heating element 230. The second non-heating element 240 may have a straight line length shorter than that of non-heating elements included in a conventional 2-zone heat generator. As an example, when the straight line length of the conventional non-heating elements is 100 mm to 120 mm, the first non-heating element 240 may have a straight line length (60 mm to 70 mm) corresponding to about 60% of the conventional length.

The second non-heating element 240 may have a second length that is shorter than or equal to the straight line length between a point on the second sub-heating element 213 and the first electrode terminal 113.

The first and second heating elements 210 and 220, the first and second non-heating elements 230 and 240, and the first and second connectors 250 and 260 may all be made of the same material, but the present disclosure is not necessarily limited thereto.

As described above, the 2-zone heat generator according to an embodiment of the present disclosure includes two non-heating elements having a shortened straight length compared to the conventional ones. Therefore, thermal stress caused by the non-heating elements can be reduced, and thereby, the occurrence of cracks in the section where the non-heating elements are in contact with the ceramic plate can be effectively reduced. In addition, with the 2-zone heat generator, the temperature uniformity of the heating surface of the ceramic heater can be improved by independently controlling the two zones of the ceramic heater heating surface to implement various temperature distributions.

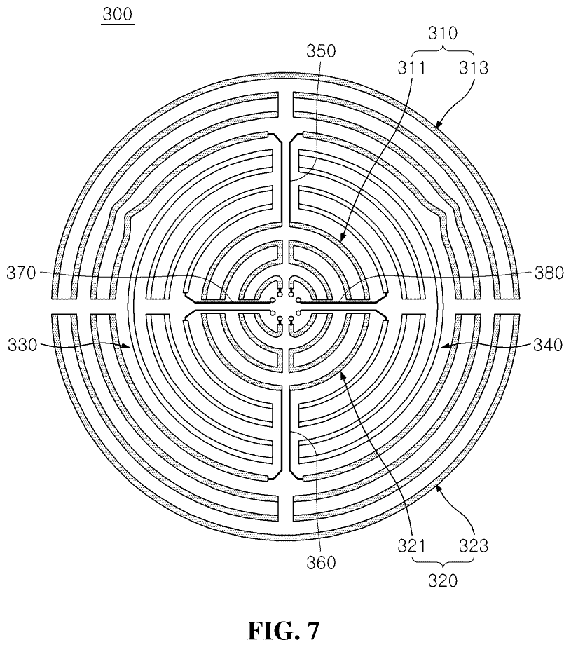

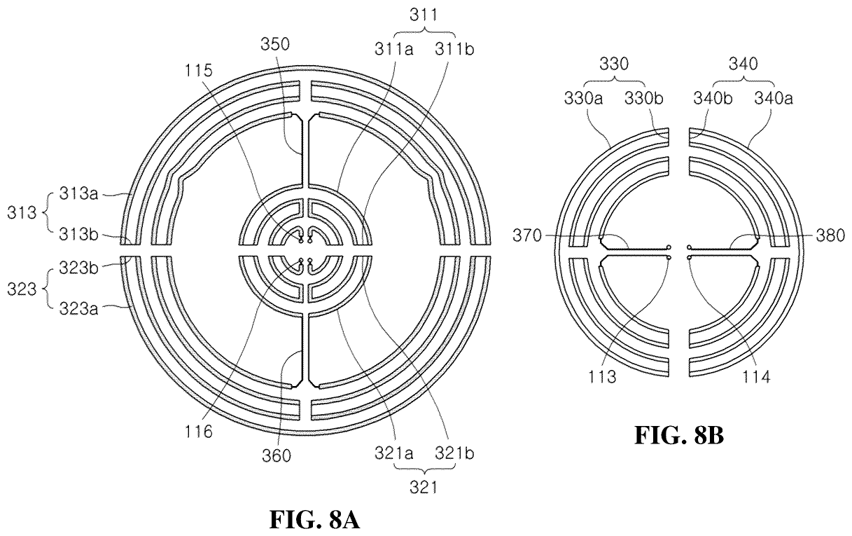

FIG. 7 is a view illustrating the structure of a 4-zone heat generator according to an embodiment of the present disclosure, and FIGS. 8A-8B are views illustrating the detailed structure of elements constituting the 4-zone heat generator of FIG. 7.

Referring to FIGS. 7 and 8A-8B, the 4-zone heat generator 300 according to an embodiment of the present disclosure may include first to fourth heating elements 310 to 340 and first to fourth non-heating elements 350 to 380.

The first heating element 310 may include a first sub-heating element 311 and a second sub-heating element 313. Here, the first and second sub-heating elements 311 and 313 may be electrically connected via the first non-heating element 350.

The second heating element 320 may include a third sub-heating element 321 and a fourth sub-heating element 323. Here, the third and fourth sub-heating elements 321 and 323 may be electrically connected via the second non-heating element 360.

The first and second heating elements 310 and 320 may be have shapes that are symmetrical to each other with respect to a horizontal axis crossing the center of the heat generator 300. In addition, the first and second heating elements 310 and 320 may be arranged opposite to each other with respect to a horizontal axis crossing the center of the heat generator 300.

The first and third sub-heating elements 311 and 321 may be provided at a location corresponding to the center zone of the heating surface of the ceramic heater. The first and third sub-heating elements 311 and 321 may include multiple concentric circles 311a and 321a and multiple joints 311b and 321b interconnecting the multiple concentric circles 311a and 321a.

The first and third sub-heating elements 311 and 321 may have the same shape. For example, the first and third sub-heating elements 311 and 321 may have a semicircular shape.

The first end of the first sub-heating element 311 may be connected to the third electrode terminal 115, and the second end may be connected to the first non-heating element 350. The first end of the third sub-heating element 321 may be connected to the fourth electrode terminal 116, and the second end may be connected to the second non-heating element 360.

The second and fourth sub-heating elements 313 and 323 may be provided at a location corresponding to the edge zone of the heating surface of the ceramic heater. The second and fourth sub-heating elements 313 and 323 may include multiple concentric circles 313a and 323a and multiple joints 313b and 323b interconnecting the multiple concentric circles 313a and 323a.

The second and fourth sub-heating elements 313 and 323 may have the same shape. For example, the second and fourth sub-heating elements 313 and 323 may have a semi-ring shape.

An end of the second sub-heating element 313 may be connected to the first non-heating element 350. An end of the fourth sub-heating element 323 may be connected to the second non-heating element 360.

The third and fourth heating elements 330 and 340 may be provided at a location corresponding to the middle zone of the heating surface of the ceramic heater. More specifically, the third heating element 330 may be disposed in the space between the first and third sub-heating elements 311 and 321 and the second and fourth sub-heating elements 313 and 323. The fourth heating element 340 may be disposed in the space between the first and third sub-heating elements 311 and 321 and the second and fourth sub-heating elements 313 and 323. The fourth heating element 340 may have a semi-ring shape.

The third and fourth heating elements 330 and 340 may have shapes that are symmetrical to each other with respect to a vertical axis crossing the center of the heat generator 300. In addition, the third and fourth heating elements 330 and 340 may be arranged opposite to each other with respect to a vertical axis crossing the center of the heat generator 300.

The third and fourth sub-heating elements 330 and 340 may have the same shape. For example, the third and fourth sub-heating elements 330 and 340 may have a semi-ring shape.

The third and fourth sub-heating elements 330 and 340 may include multiple concentric circles 330a and 340a and multiple joints 330b and 340b interconnecting the multiple concentric circles 330a and 340a.

The first to fourth heating elements 310 to 340 may be disposed on the same plane of the ceramic plate. As another embodiment, the first to fourth heating elements 310 to 340 may be disposed on different planes.

The first non-heating element 350 may be disposed between the first sub-heating element 311 and the second sub-heating element 313, and may perform the function of electrically interconnecting the first and second sub-heating elements 311 and 313. The first non-heating element 350 may extend in a straight form from a point on the first sub-heating element 311 to a point on the second sub-heating element 313.

The first non-heating element 350 may be connected to the second sub-heating element 313 via a connector (not illustrated). Meanwhile, as another embodiment, the first non-heating element 350 may be directly connected to the second sub-heating element 313 without a separate connector.

The second non-heating element 360 may be disposed between the third sub-heating element 321 and the fourth sub-heating element 323, and may perform the function of electrically interconnecting the third and fourth sub-heating elements 321 and 323. The second non-heating element 360 may extend in a straight form from a point on the third sub-heating element 321 to a point on the fourth sub-heating element 323.

The second non-heating element 360 may be connected to the fourth sub-heating element 323 via a connector (not illustrated). Meanwhile, as another embodiment, the second non-heating element 360 may be directly connected to the fourth sub-heating element 323 without a separate connector.

The first and second non-heating elements 350 and 360 may include two metal wires arranged parallel to each other. The first and second non-heating elements 350 and 360 may be provided such that the axis of symmetry between the two metal wires crosses the center of the heat generator 300.

The first and second non-heating elements 350 and 360 may have a straight line length shorter than that of non-heating elements included in a conventional 4-zone heat generator. As an example, when the straight line length of the conventional non-heating elements is 100 mm to 120 mm, the first and second non-heating elements 350 and 360 may have a straight line length (60 mm to 70 mm) corresponding to about 60% of the conventional length.

The first non-heating element 350 may have a first length that is shorter than or equal to the straight line length between a point on the second sub-heating element 313 and the third electrode terminal 115, and the second non-heating element 360 may have the first length that is shorter than or equal to the straight line length between a point on the fourth sub-heating element 323 and the fourth electrode terminal 116.

The first and second non-heating elements 350 and 360 may be arranged opposite to each other with respect to a horizontal axis crossing the center of the heat generator 300. That is, the first and second non-heating elements 350 and 360 may be arranged opposite to each other with respect to the axis of symmetry between the first heating element 310 and the second heating element 320. The first and second non-heating elements 350 and 360 may be spaced apart from the center of the heat generator 300 by a predetermined distance.

The first and second non-heating elements 350 and 360 may be arranged on a straight line crossing the center of the heat generator 300, and more preferably on a vertical line crossing the center of the heat generator 300.

The third non-heating element 370 may be arranged between the first electrode terminal 113 and the third heating element 330 and may perform the function of electrically interconnecting the first electrode terminal 113 and the third heating element 330. The third non-heating element 370 may extend in a straight form from the first electrode terminal 113 to a point on the third heating element 330.

The third non-heating element 370 may be connected to the third heating element 330 via a connector (not illustrated). Meanwhile, as another embodiment, the third non-heating element 370 may be directly connected to the third heating element 330 without a separate connector.

The fourth non-heating element 380 may be arranged between the second electrode terminal 114 and the fourth heating element 340 and may perform the function of electrically interconnecting the second electrode terminal 114 and the fourth heating element 340. The fourth non-heating element 380 may extend in a straight form from the second electrode terminal 114 to a point on the fourth heating element 340.

The fourth non-heating element 380 may be connected to the fourth heating element 340 via a connector (not illustrated). Meanwhile, as another embodiment, the fourth non-heating element 380 may be directly connected to the fourth heating element 340 without a separate connector.

The third and fourth non-heating elements 370 and 380 may include two metal wires arranged parallel to each other. The third and fourth non-heating elements 370 and 380 may be provided such that the axis of symmetry between the two metal wires crosses the center of the heat generator 300.

The third and fourth non-heating elements 370 and 380 may have a straight line length shorter than that of non-heating elements included in a conventional 4-zone heat generator. As an example, when the straight line length of the conventional non-heating elements is 100 mm to 120 mm, the third and fourth non-heating elements 370 and 380 may have a straight line length (60 mm to 70 mm) corresponding to about 60% of the conventional length.

The third non-heating element 370 may have a second length that is shorter than or equal to the straight line length between a point on either the second sub-heating element 313 or the fourth sub-heating element 323 and the first electrode terminal 113, and the fourth non-heating element 380 may have a second length that is shorter than or equal to the straight line length between a point on either the second sub-heating element 313 or the fourth sub-heating element 323 and the second electrode terminal 114. The third and fourth non-heating elements 370 and 380 may have a straight line length equal to or different from that of the first and second non-heating elements 350 and 360.

The third and fourth non-heating elements 370 and 380 may be arranged opposite to each other with respect to a vertical axis crossing the center of the heat generator 300. That is, the third and fourth non-heating elements 370 and 380 may be arranged opposite to each other with respect to the axis of symmetry between the third heating element 330 and the fourth heating element 340. In addition, the third and fourth non-heating elements 370 and 380 may be arranged on a straight line crossing the center of the heat generator 300, and more preferably on a horizontal line crossing the center of the heat generator 300.

Meanwhile, in the present embodiment, it is exemplified that the first to fourth non-heating elements 350 to 380 extend in a straight form, but the present disclosure is not necessarily limited thereto. It will be apparent to those skilled in the art that the first to fourth non-heating elements may extend in a curved form instead of the straight form, or may extend in the form in which straight and curved lines are combined.

The first to fourth heating elements 310 to 340, the first to fourth non-heating elements 350 to 380, and the first to fourth connectors (not illustrated) may all be made of the same material, but the present disclosure is not necessarily limited thereto.

As described above, the 4-zone heat generator according to an embodiment of the present disclosure includes four non-heating elements with a shortened straight length compared to the conventional ones. Therefore, thermal stress caused by the non-heating elements can be reduced, and thereby, the occurrence of cracks in the section where the non-heating elements are in contact with the ceramic plate can be effectively reduced. In addition, with the 4-zone heat generator, the temperature uniformity of the heating surface of the ceramic heater can be improved by independently controlling the four zones of the ceramic heater heating surface to implement various temperature distributions.

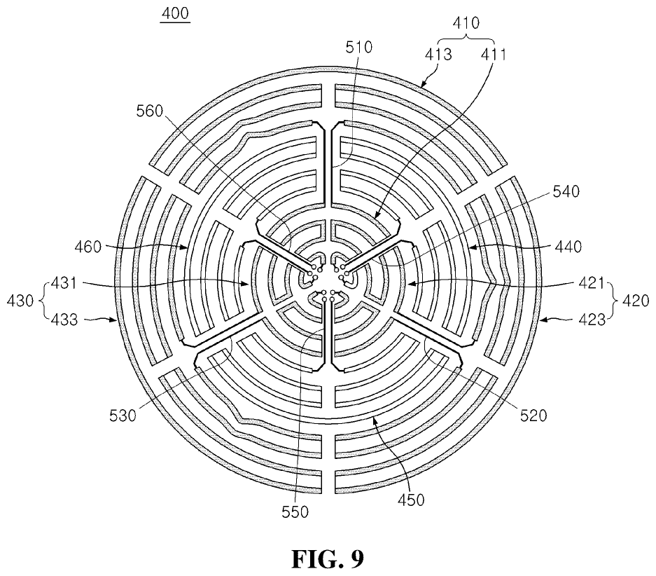

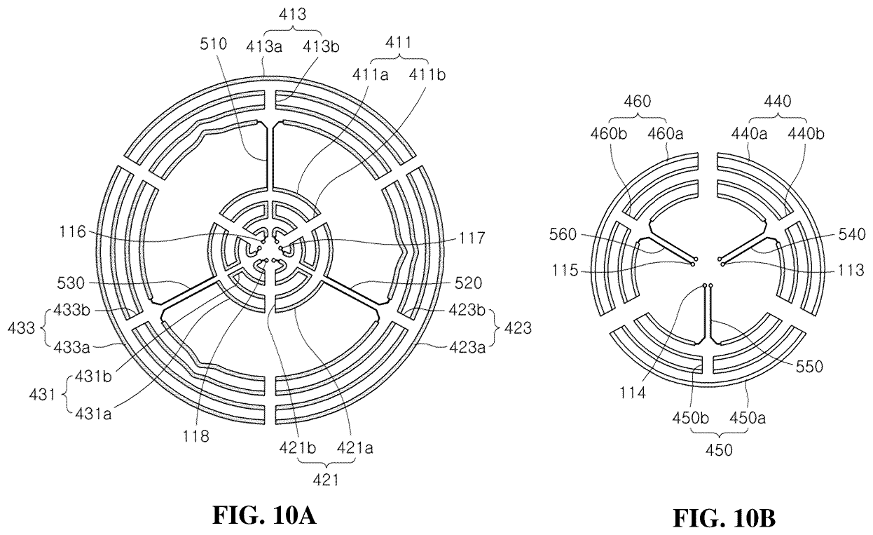

FIG. 9 is a view illustrating the structure of a 6-zone heat generator according to an embodiment of the present disclosure, FIGS. 10A-10B are views illustrating the detailed structure of elements constituting the 6-zone heat generator of FIG. 9.

Referring to FIGS. 9 and 10A-10B, the 6-zone heat generator 400 according to an embodiment of the present disclosure may include first to sixth heating elements 410 to 460 and first to sixth non-heating elements 510 to 560.

The first heating element 410 may include a first sub-heating element 411 and a second sub-heating element 413. Here, the first and second sub-heating elements 411 and 413 may be electrically connected via the first non-heating element 510.

The second heating element 420 may include a third sub-heating element 421 and a fourth sub-heating element 423. Here, the third and fourth sub-heating elements 421 and 423 may be electrically connected via the second non-heating element 520.

The third heating element 430 may include a fifth sub-heating element 431 and a sixth sub-heating element 433. Here, the fifth and sixth sub-heating elements 431 and 433 may be electrically connected via the third non-heating element 530.

The first, third, and fifth sub-heating elements 411, 421, and 431 may be provided at a location corresponding to the center zone of the heating surface of the ceramic heater. The first, third, and fifth sub-heating elements 411, 421, and 431 may include multiple concentric circles 411a, 421a, and 431a and multiple joints 411b, 421b, and 431b interconnecting the multiple concentric circles 411a, 421a, and 431a.

The first, third, and fifth sub-heating elements 411, 421, and 431 may have the same shape. For example, the first, third, and fifth sub-heating elements 411, 421, and 431 may have a fan shape.

The first end of the first sub-heating element 411 may be connected to the fourth electrode terminal 116, and the second end may be connected to the first non-heating element 510. The first end of the third sub-heating element 421 may be connected to the fifth electrode terminal 117, and the second end may be connected to the second non-heating element 520. The first end of the fifth sub-heating element 431 may be connected to the sixth electrode terminal 118, and the second end may be connected to the third non-heating element 530.

The second, fourth, and sixth sub-heating elements 413, 423, and 433 may be provided at a location corresponding to the edge zone of the heating surface of the ceramic heater. The second, fourth, and sixth sub-heating elements 413, 423, and 433 may include multiple concentric circles 413a, 423a, and 433a and multiple joints 413b, 423b, and 433b interconnecting the multiple concentric circles 413a, 423a, and 433a.

The second, fourth, and sixth sub-heating elements 413, 423, and 433 may have the same shape. As an example, the second, fourth, and sixth sub-heating elements 413, 423, and 433 may have shapes obtained by dividing a ring into three equal portions, respectively.

An end of the second sub-heating element 413 may be connected to the first non-heating element 510. An end of the fourth sub-heating element 423 may be connected to the second non-heating element 520. An end of the sixth sub-heating element 433 may be connected to the third non-heating element 530.

The fourth to sixth heating elements 440 to 460 may be provided at a location corresponding to the middle zone of the heating surface of the ceramic heater. More specifically, the fourth heating element 440 may be disposed in the space between the first and third sub-heating elements 411 and 421 and the second and fourth sub-heating elements 413 and 423. The fifth heating element 450 may be disposed in the space between the third and fifth sub-heating elements 421 and 431 and the fourth and sixth sub-heating elements 423 and 433. The sixth heating element 460 may be disposed in the space between the first and fifth sub-heating elements 411 and 431 and the second and sixth sub-heating elements 413 and 433.

The fourth to sixth heating elements 440 to 460 may have the same shape. For example, the fourth to sixth heating elements 440 to 460 may have shapes obtained by dividing a ring into three equal portions, respectively.

The fourth to sixth heating elements 440, and 460 may include multiple concentric circles 440a, 450a, and 460a and multiple joints 440b, 450b, and 460b interconnecting the multiple concentric circles 440a, 450a, and 460a.

The first to sixth heating elements 410 to 460 may be disposed on the same plane of the ceramic plate. As another embodiment, the first to sixth heating elements 410 to 460 may be disposed on different planes.

The first non-heating element 510 may be disposed between the first sub-heating element 411 and the second sub-heating element 413, and may perform the function of electrically interconnecting the first and second sub-heating elements 411 and 413. The first non-heating element 510 may extend in a straight form from a point on the first sub-heating element 411 to a point on the second sub-heating element 413.

The first non-heating element 510 may be connected to the second sub-heating element 413 via a connector (not illustrated). Meanwhile, as another embodiment, the first non-heating element 510 may be directly connected to the second sub-heating element 413 without a separate connector.

The second non-heating element 520 may be disposed between the third sub-heating element 421 and the fourth sub-heating element 423, and may perform the function of electrically interconnecting the third and fourth sub-heating elements 421 and 423. The second non-heating element 520 may extend in a straight form from a point on the third sub-heating element 421 to a point on the fourth sub-heating element 423.

The second non-heating element 520 may be connected to the fourth sub-heating element 423 via a connector (not illustrated). Meanwhile, as another embodiment, the second non-heating element 520 may be directly connected to the fourth sub-heating element 423 without a separate connector.

The third non-heating element 530 may be disposed between the fifth sub-heating element 431 and the sixth sub-heating element 433, and may perform the function of electrically interconnecting the fifth and sixth sub-heating elements 431 and 433. The third non-heating element 530 may extend in a straight form from a point on the fourth sub-heating element 431 to a point on the sixth sub-heating element 433.

The third non-heating element 530 may be connected to the sixth sub-heating element 433 via a connector (not illustrated). Meanwhile, as another embodiment, the third non-heating element 530 may be directly connected to the sixth sub-heating element 433 without a separate connector.

The first to third non-heating elements 510 to 530 may include two metal wires arranged parallel to each other. The first to third non-heating elements 510 to 530 may be provided such that the axis of symmetry between the two metal wires crosses the center of the heat generator 400.

The first to third non-heating elements 510 to 530 may have a straight line length shorter than that of non-heating elements included in a conventional 6-zone heat generator. As an example, when the straight line length of the conventional non-heating elements is 100 mm to 120 mm, the first to third non-heating elements 510 to 530 may have a straight line length (60 mm to 70 mm) corresponding to about 60% of the conventional length.

The first non-heating element 510 may have a first length that is shorter than or equal to the straight line length between a point on the second sub-heating element 413 and the fourth electrode terminal 116, the second non-heating element 520 may have the first length that is shorter than or equal to the straight line length between a point on the fourth sub-heating element 423 and the fifth electrode terminal 117, and the third non-heating element 530 may have the first length that is shorter than or equal to the straight line length between a point on the sixth sub-heating element 433 and the sixth electrode terminal 118.

The first to third non-heating elements 510 to 530 may be arranged at 120-degree intervals around the center of the heat generator 400. The first to second non-heating elements 510 to 530 may be spaced apart from the center of the heat generator 400 by a predetermined distance. The first to third non-heating elements 510 to 530 may have the same straight line length.

The fourth non-heating element 540 may be arranged between the first electrode terminal 113 and the fourth heating element 440 and may perform the function of electrically interconnecting the first electrode terminal 113 and the fourth heating element 440. The fourth non-heating element 540 may extend in a straight form from the first electrode terminal 113 to a point on the fourth heating element 440.

The fourth non-heating element 540 may be connected to the fourth heating element 440 via a connector (not illustrated). Meanwhile, as another embodiment, the fourth non-heating element 540 may be directly connected to the fourth heating element 440 without a separate connector.

The fifth non-heating element 550 may be arranged between the second electrode terminal 114 and the fifth heating element 450 and may perform the function of electrically interconnecting the second electrode terminal 114 and the fifth heating element 450. The fifth non-heating element 550 may extend in a straight form from the second electrode terminal 114 to a point on the fifth heating element 450.

The fifth non-heating element 550 may be connected to the fifth heating element 450 via a connector (not illustrated). Meanwhile, as another embodiment, the fifth non-heating element 550 may be directly connected to the fifth heating element 450 without a separate connector.

The sixth non-heating element 560 may be arranged between the third electrode terminal 115 and the sixth heating element 460 and may perform the function of electrically interconnecting the third electrode terminal 115 and the sixth heating element 460. The sixth non-heating element 560 may extend in a straight form from the third electrode terminal 115 to a point on the sixth heating element 460.

The sixth non-heating element 560 may be connected to the sixth heating element 460 via a connector (not illustrated). Meanwhile, as another embodiment, the sixth non-heating element 560 may be directly connected to the sixth heating element 460 without a separate connector.

The fourth to sixth non-heating elements 540 to 560 may include two metal wires arranged parallel to each other. The fourth to sixth non-heating elements 540 to 560 may be provided such that the axis of symmetry between the two metal wires crosses the center of the heat generator 400.

The fourth to sixth non-heating elements 540 to 560 may have a straight line length shorter than that of non-heating elements included in a conventional 6-zone heat generator. As an example, when the straight line length of the conventional non-heating elements is 100 mm to 120 mm, the fourth to sixth non-heating elements 540 to 560 may have a straight line length (60 mm to 70 mm) corresponding to about 60% of the conventional length.

The fourth non-heating element 540 may have a second length that is shorter than or equal to the straight line length between a point on one of the second, fourth, and sixth sub-heating element 413, 423, and 433 and the first electrode terminal 113, the fifth non-heating element 550 may have the second length that is shorter than or equal to the straight line length between a point on one of the second, fourth, and sixth sub-heating element 413, 423, and 433 and the second electrode terminal 114, and the sixth non-heating element 560 may have the second length that is shorter than or equal to the straight line length between a point on one of the second, fourth, and sixth sub-heating element 413, 423, and 433 and the third electrode terminal 115. The fourth to sixth non-heating elements 540 to 560 may have a straight line length equal to or different from that of the first to third non-heating elements 510 to 530.

The fourth to sixth non-heating elements 540 to 560 may be arranged at 120-degree intervals around the center of the heat generator 400. The fourth to sixth non-heating elements 540 to 560 may have the same straight line length.

Meanwhile, in the present embodiment, it is exemplified that the first to sixth non-heating elements 510 to 560 extend in a straight form, but the present disclosure is not necessarily limited thereto. It will be apparent to those skilled in the art that the first to fourth non-heating elements may extend in a curved form instead of the straight form, or may extend in the form in which straight and curved lines are combined.

The first to sixth heating elements 410 to 460, the first to sixth non-heating elements 510 to 560, and the first to fourth connectors (not illustrated) may all be made of the same material, but the present disclosure is not necessarily limited thereto.

As described above, the 6-zone heat generator according to an embodiment of the present disclosure includes six non-heating elements with a shortened straight length compared to the conventional ones. Therefore, thermal stress caused by the non-heating elements and be reduced, and thereby, the occurrence of cracks in the area where the non-heating elements and the ceramic plate are in contact with each other can be effectively reduced. In addition, with the 6-zone heat generator, the temperature uniformity of the heating surface of the ceramic heater can be improved by independently controlling the six zones of the ceramic heater heating surface to implement various temperature distributions.

Although specific embodiments of the present disclosure have been described above, it is of course possible to make various modifications without departing from the scope of the present disclosure. Therefore, the scope of the present disclosure is not limited to the described embodiments, and should be determined based not only on the claims to be described later, but also on equivalents to the claims.

1. A ceramic heater comprising a 2-zone heat generator,
wherein the 2-zone heat generator comprises:
first and second heating elements configured to be independently controllable by a power supply;
a first non-heating element arranged between first and second sub-heating elements constituting the first heating element and electrically interconnecting the first and second sub-heating elements; and
a second non-heating element disposed between the second heating element and a first electrode terminal and electrically interconnecting the second heating element and the first electrode terminal.

2. The ceramic heater of claim 1, wherein the first sub-heating element is disposed at a position corresponding to a center zone of a heating surface of the ceramic heater,
wherein the second sub-heating element is disposed at a position corresponding to an edge zone of the heating surface of the ceramic heater, and
wherein the second heating element is disposed at a position corresponding to a middle zone of the heating surface of the ceramic heater.

3. The ceramic heater of claim 1, wherein the first non-heating element has a first length that is shorter than or equal to a straight line length between a point on the second sub-heating element and a second electrode terminal connected to the first sub-heating element, and
wherein the second non-heating element has a second length that is shorter than or equal to a straight line length between a point on the second sub-heating element and the first electrode terminal.

4. The ceramic heater of claim 1, wherein the first non-heating element extends in a straight or curved form from a point on the first sub-heating element to a point on the second sub-heating element, and
wherein the second non-heating element extends in a straight or curved form from the first electrode terminal to a point on the second heating element.

5. The ceramic heater of claim 1, wherein the first non-heating element is connected to the second sub-heating element via a first connector, and
wherein the second non-heating element is connected to the second heating element via a second connector.

6. The ceramic heater of claim 1, wherein the first and second non-heating elements are disposed on a straight line crossing a center of the 2-zone heat generator.

7. The ceramic heater of claim 1, wherein the first and second non-heating elements are disposed opposite to each other with respect to a center of the 2-zone heat generator.

8. The ceramic heater of claim 1, wherein the first and second non-heating elements comprise two metal wires arranged parallel to each other, and an axis of symmetry between the two metal wires extends across a center of the 2-zone heat generator.

9. A ceramic heater comprising a 4-zone heat generator,
wherein the 4-zone heat generator comprises:
first to fourth heating elements configured to be independently controlled by a power supply;
first and second non-heating elements arranged opposite to each other with respect to a first axis of symmetry between the first heating element and the second heating element, and disposed at a predetermined distance from a center of the 4-zone heat generator; and
third and fourth non-heating elements arranged opposite to each other with respect to a second axis of symmetry between the third heating element and the fourth heating element, and extending from first and second electrode terminals disposed at a center of the 4-zone heat generator toward the third and fourth heating elements.

10. The ceramic heater of claim 9, wherein the second axis of symmetry is perpendicular to the first axis of symmetry.

11. The ceramic heater of claim 9, wherein the first and second axes of symmetry pass through the center of the 4-zone heat generator.

12. The ceramic heater of claim 9, wherein the first non-heating element is arranged between first and second sub-heating elements constituting the first heating element, and electrically interconnects the first and second sub-heating elements,
wherein the second non-heating element is arranged between third and fourth sub-heating elements constituting the second heating element, and electrically interconnects the third and fourth sub-heating elements,
wherein the third non-heating element is arranged between the third heating element and the first electrode terminal, and electrically interconnects the third heating element and the first electrode terminal, and
wherein the third non-heating element is arranged between the third heating element and the first electrode terminal, and electrically interconnects the third heating element and the first electrode terminal.

13. The ceramic heater of claim 12, wherein the first non-heating element has a first length that is shorter than or equal to a straight line length between a point on the second sub-heating element and a third electrode terminal connected to the first sub-heating element,
wherein the second non-heating element has the first length that is shorter than or equal to a straight line length between a point on the fourth sub-heating element and a fourth electrode terminal connected to the third sub-heating element,
wherein the third non-heating element has a second length that is shorter than or equal to a straight line length between the first electrode terminal and a point on one of the second sub-heating element and the fourth sub-heating element, and
wherein the fourth non-heating element has the second length that is shorter than or equal to a straight line length between the second electrode terminal and a point on one of the second sub-heating element and the fourth sub-heating element.

14. The ceramic heater of claim 9, wherein each of the first to fourth non-heating elements extends in a straight or curved form.

15. The ceramic heater of claim 9, wherein the first to fourth non-heating elements are connected to the first to fourth heating elements via connectors, respectively.

16. A ceramic heater comprising a 6-zone heat generator,
wherein the 6-zone heat generator comprises:
first to sixth heating elements configured to be independently controlled by a power supply;
first to third non-heating elements disposed at a predetermined distance from a center of the 6-zone heat generator and arranged at 120-degree intervals around a center of the 6-zone heat generator; and
fourth to sixth non-heating elements extending from the first to third electrode terminals disposed in the center of the 6-zone heat generator toward the fourth to sixth heating elements, respectively, and arranged at 120-degree intervals around the center of the 6-zone heat generator.

17. The ceramic heater of claim 16, wherein the first non-heating element is arranged between first and second sub-heating elements constituting the first heating element, and electrically interconnects the first and second sub-heating elements,
wherein the second non-heating element is arranged between third and fourth sub-heating elements constituting the second heating element, and electrically interconnects the third and fourth sub-heating elements,
wherein the third non-heating element is arranged between fifth and sixth sub-heating elements constituting the third heating element, and electrically interconnects the fifth and sixth sub-heating elements,
wherein the fourth non-heating element is arranged between the fourth heating element and the first electrode terminal, and electrically interconnects the fourth heating element and the first electrode terminal,
wherein the fifth non-heating element is arranged between the fifth heating element and the second electrode terminal, and electrically interconnects the fifth heating element and the second electrode terminal, and
wherein the sixth non-heating element is arranged between the sixth heating element and the third electrode terminal, and electrically interconnects the sixth heating element and the third electrode terminal.

18. The ceramic heater of claim 17, wherein the first non-heating element has a first length that is shorter than or equal to a straight line length between a point on the second sub-heating element and a fourth electrode terminal connected to the first sub-heating element,
wherein the second non-heating element has the first length that is shorter than or equal to a straight line length between a point on the fourth sub-heating element and a fifth electrode terminal connected to the third sub-heating element,
wherein the third non-heating element has the first length that is shorter than or equal to a straight line length between a point on the sixth sub-heating element and a sixth electrode terminal connected to the fifth sub-heating element,
wherein the fourth non-heating element has a second length that is shorter than or equal to a straight line length between the first electrode terminal and a point on one of the second, fourth, and sixth sub-heating elements,
wherein the fifth non-heating element has the second length that is shorter than or equal to a straight line length between the second electrode terminal and a point on one of the second, fourth, and sixth sub-heating elements, and
wherein the sixth non-heating element has the second length that is shorter than or equal to a straight line length between the third electrode terminal and a point on one of the second, fourth, and sixth sub-heating elements.

19. The ceramic heater of claim 16, wherein each of the first to sixth non-heating elements extends in a straight or curved form.

20. The ceramic heater of claim 16, wherein the first to sixth non-heating elements are connected to the first to sixth heating elements via connectors, respectively.
